(19) United States
(12) Patent Application Publication
(10) Pub. No.: US 2015/0023278 A1
(43) Pub. Date: Jan. 22, 2015

(54) APPARATUS, METHOD AND COMPUTER PROGRAM FOR CONTROLLING TRANSMISSION POINTS IN A MOBILE COMMUNICATION SYSTEM

(71) Applicant: Alcatel Lucent, Boulogne Billancourt (FR)

(72) Inventors: Federico Boccardi, Vimercate (IT); Uwe Doetsch, Stuttgart (DE)

(73) Assignee: Alcatel Lucent, Boulogne Billancourt (FR)

(21) Appl. No.: 14/381,700

(22) PCT Filed: Feb. 21, 2013
(86) PCT No.: PCT/EP2013/053491

§ 371 Date: Aug. 28, 2014

(30) Foreign Application Priority Data
Feb. 28, 2012 (EP) 12305240.9
Aug. 20, 2012 (EP) 12306010.5

(51) Int. Cl. H04L 5/00

(52) U.S. Cl. CPC H04L 5/0048
USPC 370/329

(57) ABSTRACT

Embodiments provide an apparatus, a method and a computer program for controlling transmission points in a mobile communication system. The apparatus (10) is operable to control transmission points (200, 210, 220, 230, 240, 250) in a mobile communication system (300). The mobile communication system (300) comprises a plurality of transmission points (200, 210, 220, 230, 240, 250), which are operable to communicate radio signals with a mobile transceiver (400). The apparatus (10) comprises means for forming (12) a cluster (500) of transmission points, the cluster (500) of transmission points comprises multiple transmission points (200, 210), the transmission points (200, 210) of the cluster (500) using a common reference signal.

### BACKGROUND

Embodiments of the present invention relate to communication networks, more particularly but not exclusively to resource allocation in mobile communication networks.

Demands for higher data rates for mobile services are steadily increasing. At the same time modern mobile communication systems as 3rd Generation systems (3G) and 4th Generation systems (4G) provide enhanced technologies, which enable higher spectral efficiencies and allow for higher data rates and cell capacities. As operators are seeking to extend the coverage and capacity of their networks advanced transmission concepts are one way forward.

Some of these advanced transmission concepts may include joint user scheduling, i.e. users or mobile transceivers of a communication network are jointly scheduled for data transmission and/or reception. Cell clustering is another concept wherein cells are grouped or clustered for simultaneous transmission to a mobile transceiver, which may then take advantage of diversity and combining gains. Moreover, advanced antenna concepts, such as beamforming and Multiple-Input-Multiple-Output (Ml MO) transmission, may use precoding coefficient calculation methods, which consider multiple transceivers. In some concepts a central logical entity may jointly form clusters of coordinated cells, select users and calculate beamforming coefficients and power allocations.

### SUMMARY

Embodiments are based on the finding that advanced transmission concepts can be combined with cloud architectures. For example, a Radio Access Network (RAN) of a mobile communication system may be implemented as a Cloud-RAN (C-RAN). In a C-RAN advantage may be taken of cloud computing, i.e. processing resources are provided at centralized network entities and radio front ends are provided as remote units or transmission points. The transmission points can be coupled with the central units comprising the processing resources using high capacity data lines, such as optical fiber. The processing resources at the centralized network entity are also referred to as Base Band Units (BBU) or base band processing units. The Transmission Points (TPs) comprise the radio front ends and may operate one or more antennas for transmitting and receiving radio signals.

It is another finding that different TPs connected to a Central Unit (CU) can be grouped into clusters and each cluster can be dynamically mapped to a set of processing resources into the network. The same TP can belong to different clusters and therefore the signal received by a TP can be routed to different processing resources within the network (equivalently for the signal transmitted). More details can be found in European patent application no. EP12305240.9. It is a further finding that TP clusters can be efficiently created without introducing a too high computational complexity and a too high signaling overhead in the air-interface.

According to another finding the problem of TP clustering is connected to the problem of user scheduling, multi-antenna transmit/receive beamforming and power control. Therefore an optimal solution of this problem would require a joint optimal solution of different sub-problems at different levels of the protocol stack. Therefore, in literature the joint problem is usually decomposed in different sub problems one of which being dynamic clustering.

In “A Framework for Optimizing the Uplink Performance of Distributed Antenna Systems under a Constrained Backhaul”, P. Marsch and G. Fettweis, in Proc. Of ICC April 2007, and P. Marsch and G. Fettweis, “A Framework for Optimizing the Downlink Performance of Distributed Antenna Systems under a Constrained Backhaul”, in Proc. of EW, April 2007, the authors consider an approach for uplink and downlink transmissions such that the users are divided in groups using orthogonal resources. Joint detection can be used between users belonging to the same group. Weak users (i.e. users at the edge of the cells) can be grouped together and the TP coordination may be realized starting from the weak users until the constraint on the backhaul is achieved. The grouping can be realized considering only average channel state information, without exploiting instantaneous dynamics of the channel.

S. Venkatesan, “Coordinating base stations for grater uplink spectral efficiency in a cellular systems”, in Proc. of PIMRC, September 2007 presents a TP selection algorithm that refers to the uplink problem. The goal is to minimize the power in order to achieve an equal-rate requirement. Power allocation, receive (linear) beamforming and cluster assignment are jointly realized using an extension of the algorithm proposed by F. Rashid-Farrokhi, L. Tassiulas and K. J. R. Liu in “Joint optimal power control and beamforming in wireless networks using antenna arrays”, IEEE Trans. Commun., vol. 46, pp. 1313-1324, October 1998. A limitation of this work is the lack of diversity with respect to changing channel conditions.

In A. Papadogiannis, D. Gesbert and E. Hardouin, “A dynamic clustering approach in wireless networks with multi-cell cooperative processing”. in Proc. of ICC 08, a dynamic clustering technique is considered for uplink transmissions in order to maximize the weighted sum-rate. At each time slot one user per cell is selected using round robin scheduling. At that time slot and for those specific selected users the algorithm chooses the best bases in order to serve those users using joint combining.

Document WO 2010/016865 A1 discloses an approach where clustering and user scheduling are solved jointly in order to maximize a common metric. Current solutions for dynamic TP clustering are still unpractical because of their complexity. One problem is feedback overhead that comes along with conventional concepts. As a matter of fact, to jointly create the optimal clustering and schedule a convenient set of users, the logical central unit in charge of the process should use the Channel State Information (CSI) from each TP to each user. While in an uplink Time Division Duplex/Frequency Division Duplex (TDD/FDD) and downlink TDD system this can be feasible, assuming properly designed reference signals, in a downlink FDD system it requires a large feedback overhead. Each UE should send multiple pieces of feedback information for each candidate TP point. For example, assuming a feedback mechanism built on the Precoding Matrix Index (PMI)/Channel Quality Information (CQI)/Rate Information (RI) structure used in Long Term Evolution (LTE), a natural enabler for dynamic clustering would involve sending a triple PMI/CQI/RI for each TP, plus some feedback signaling for the phase difference between different TPs, plus CQI and RI information about the joint channel between different TPs.

Based on another finding another problem is computational complexity. As a matter of fact jointly solving clustering and scheduling would require the solution of unpractical full-search algorithms. Even greedy-search based suboptimal algorithms would still be demanding from a computational complexity point of view, as shown in WO 2010/016865 A1. Based on these findings embodiments may provide a reduction in computational complexity and/or a lowering feedback overhead.

Embodiments are further based on the finding that clusters of TPs can use a common reference signal, i.e. a reference signal, which is common to the TPs of said cluster. In other words, the TPs of one cluster use the same common reference signal. The TPs of the cluster may further use the same cell identification such that they may appear as a single cell to a mobile. In other words, embodiments may randomly generate sets of clusters of transmission points and transmit per cluster reference signals. This operation may also be referred to as cluster scheduling. For each scheduled set of clusters a feedback from each user may be collected and the best user may be scheduled, according to a certain metric. Embodiments may therewith differ from previous proposals further in that reference signals can be sent per cluster and not per transmission point. In the same way, feedback can be received per-cluster and not per transmission point. Another difference is the mechanism used at the central unit to generate clusters. While previous proposals use a mechanism for relying on the feedback received at each TP to group TPs, embodiments may use different mechanisms to form a cluster,

Embodiments provide an apparatus for controlling transmission points in a mobile communication system, i.e. embodiments may provide said apparatus to be operated by or included in a base station transceiver or a network entity. The mobile communication system may, for example, correspond to one of the mobile communication systems standardized by the 3^{rd} Generation Partnership Project (3GPP), as Global System for Mobile Communications (GSM), Enhanced Data rates for GSM Evolution (EDGE), GSM EDGE Radio Access Network (GERAN), Universal Terrestrial Radio Access Network (UTRAN) or Evolved UTRAN (E-UTRAN), Long Term Evolution (LTE) or LTE-Advanced (LTE-A), or mobile communication systems with different standards, e.g. Worldwide Interoperability for Microwave Access (WIMAX) IEEE 802.16 or Wireless Local Area Network (WEAN) IEEE 802.11, generally any system based on Time Division Multiple Access (TDMA), Frequency Division Multiple Access (FDMA), Orthogonal Frequency Division Multiple Access (OFDMA), Code Division Multiple Access (CDMA), etc. In the following the terms mobile communication system and mobile communication network are used synonymously.

The mobile communication system comprises a plurality of transmission points operable to communicate radio signals with a mobile transceiver. In embodiments, the mobile communication system may comprise mobile transceivers and base station transceivers. A mobile transceiver may correspond to a smartphone, a cell phone, user equipment, a laptop, a notebook, a personal computer, a Personal Digital Assistant (PDA), an Universal Serial Bus (USB) -stick, a car, etc. A mobile transceiver may also be referred to as User Equipment (UE) or user in line with the 3GPP terminology. A base station transceiver can be located in the fixed or stationary part of the network or system. A base station transceiver may correspond to a remote radio head, a transmission point, an access point, a macro cell, a small cell, a micro cell, a femto cell, a metro cell etc. A base station transceiver can be a wireless interface of a wired network, which enables transmission of radio signals to a UE or mobile transceiver. Such a radio signal may comply with radio signals as, for example, standardized by 3GPP or generally, in line with one or more of the above listed systems. Thus, a base station transceiver may correspond to a NodeB, an eNodeB, a BTS, an access point, etc.

The mobile communication system comprises a plurality of transmission points operable to communicate radio signals with a mobile transceiver. Moreover, the mobile communication system comprises a plurality of processing resources operable to process the radio signals communicated with the mobile transceiver. The apparatus comprises means for forming a cluster of transmission points, the cluster of transmission points comprising multiple transmission points, each of which use a common reference signal.

In embodiments the common reference signal may be established by precoded reference signals transmitted by the TPs of a cluster. In other words the references symbols which are transmitted by the TPs of a cluster may be precoded in that phase adjustments or amplitude adjustments or both are carried out at one or more TPs of the cluster. Moreover, it is assumed that the TPs of one cluster are synchronized to a certain extent. In some embodiments the TPs selected for a cluster transmit the same reference signals in a synchronized, i.e. slot synchronized, manner. Whether these signals superimpose coherently at a mobile transceiver then depends on the individual radio channels between each of the TPs and the respective mobile. For example, a TP may correspond to a certain first antenna of a first base station and it may be combined with another antenna of another base station to form a cluster. Throughout the coverage area of the so-formed cluster opportunistic beamforming may be established, meaning that at some locations the signals of the TPs may superimpose coherently and at other locations they may superimpose incoherently. Subsequent scheduling can take advantage of this opportunistic beamforming,

In some embodiments, the apparatus, the means for forming respectively, may calculate precoding weights based on channel prediction for the cluster. Such channel prediction may in some embodiments be based on channel statistics, channel data history, etc. The TPs may then send precoded pilots or reference symbols. Based on the precoded pilots the UE may measure or estimate the joint radio channel as if it was established by a single TP only Accordingly, the mobile transceiver may provide information on the channel quality as in a single TP case, e.g. in terms of Channel Quality Information (CQI) channel feedback to the TP(s). In return the apparatus may schedule the TPC and therewith the mobile transceiver based on the feedback information on the joint or common radio channel. The TPC may send precoded pilots and data together.

In further embodiments the transmission points of the cluster may use a same cell identification. In some embodiments such a same cell identification may be established by the common reference signal, which will be described in more detail subsequently. The means for forming can correspond to a cluster former, i.e. a device or an entity to form a group of TPs to form a cluster. Such a cluster former may be established using a processor, a controller or other hardware, which is capable of executing a corresponding computer program. In further embodiments optimization techniques may be used to schedule the set of TPs to form a cluster, to which is also referred as TP Cluster (TPC).

The mobile transceiver can be associated with the TPC, which may establish a TPC-cell. A TPC-cell may differ from a conventional cell, the TPC-cell may be established by multiple TPs. The term cell refers to a coverage area of radio services provided by a TPC, a TP, a base station transceiver or a NodeB, an eNodeB, respectively. In some embodiments a cell may correspond to a sector. For example, sectors can be achieved using sector antennas, which provide a characteristic for covering an angular section around a TP or base station transceiver. In some embodiments, a TP may, for example, operate three or six cells covering sectors of 120° (in case of three cells), 60° (in case of six cells) respectively. A mobile transceiver can be registered or associated with a cell, i.e. it can be associated to a cell such that data can be exchanged between the network and the mobile in the coverage area of the associated cell using a dedicated channel, link or connection. The means for forming can be operable to allocate one or more cell identifications of cells of the mobile communication system to a TP and one cell identification to a TPC.

A cell is thus operated by one or more TPs and can be seen as a coverage area, which can be identified through reference or broadcast channels with a respective identification, as, for example, a pilot channel. Before a mobile transceiver can transmit payload data to a cell, it has to register, associate or connect with a cell. A mobile transceiver not registered with a cell is in a so called idle mode, a registered mobile transceiver is in active or connected mode. One prominent protocol of the 3GPP specifications is the Radio Resource Control (RRC) protocol, cf. Technical Specification (TS) 25.331/36.331 series of 3GPP specifications. RRC specifies multiple procedures for radio resource management of a mobile transceiver, as handover signaling, measurement configuration, cell reselection, reconfiguration, etc. Once a mobile transceiver has established an RRC connection to the respective network entity, e. g. a TP, a NodeB, a Radio Network Controller (RNC), an eNodeB, etc., the network entity can trigger the respective procedures, which is why an associated mobile transceiver is also be referred to as in RRC connected mode when associated to a TP.

In further embodiments the apparatus can be operable to control the transmission points such that the transmission points are operable to indicate their cell identification using a scrambling code for transmitting a broadcast signal, i.e. the TPs use the same scrambling code. In other embodiments the same cell ID may be provided using other techniques, such as transmission of identical cell identification information on respective system information or broadcast channels. In some embodiments the apparatus can be further operable to control the transmission points such that transmission points appear as one radio cell to a mobile transceiver. In other words, the apparatus may control the transmission points of a cluster such that the transmission points appear to a mobile within the coverage area of the cluster as a single radio cell. Such control may involve using one and the same cell identification for the TPs of the cluster, certain synchronization needs between the TPs of the cluster and/or using common reference signals in the cluster.

In some embodiments the apparatus can be further operable to control the transmission points such that transmission points provide the common reference signal. The common reference signal can be such that a joint radio channel, being established between the transmission points of the cluster and a mobile transceiver, is measurable based on the common reference signal by the mobile transceiver. Hence, the TPs of the cluster may provide a common reference signal, e.g. a pilot signal or channel, which is synchronized to a certain extent. The mobile transceiver can then receive said common reference signal and measure or estimate a common radio channel of the TPs of the cluster. The common reference signal may correspond to a cell-specific reference signal or a demodulation reference signal. For example, in an LTE network, in order to allow for coherent demodulation and channel estimation at the mobile, reference symbols or pilot symbols are used in the OFDM time-frequency grid.

Downlink reference symbols can be inserted with a certain spacing in the time domain, e.g. in the first and third last OFDM symbol of each slot, and with a frequency domain spacing, e.g. every certain number of sub-carriers such as every sixth sub-carrier. The mobile transceiver may then interpolate over multiple reference symbols to estimate the channel. The reference symbols may be complex valued and they may be determined according to the symbol position as well as according to the cell. LTE specifications refer to this as a two-dimensional reference-signal sequence, which indicates the LTE cell identity. There are 510 reference signal sequences corresponding to 510 different cell identities. The reference signals are derived from the product of a two-dimensional pseudo-random sequence and a two-dimensional orthogonal sequence. There are 170 different pseudo-random sequences corresponding to 170 cell-identity groups, and three orthogonal sequences each corresponding to a specific cell identity within the cell identity group.

For example, different Reference Signal (RS) paradigms may be used in embodiments such as Cell-specific RS (CRS) or user-specific RS. Such a choice may depend on multi-antenna techniques to be used, such as Multi-User MIMO (MU-MIMO) and Cooperative MultiPoint(CoMP) transmission, for which considerable flexibility in determining precoders is needed to limit interference between co-scheduled users. The user-specific RS may offer an advantage in that respect by providing the TPC with complete freedom in determining a precoder for the data transmission to a user as long as the same precoder is used for the user-specific RS and the data within a scheduling unit. The way the transmission is performed hence becomes transparent from a user point of view, offering flexibility to even transmit signals from two widely separated sites (i.e. CoMP) without the user needing to be aware of it.

Some embodiments may comply with LIE Release 10 RS, which is based on separate RS for demodulation and CSI feedback. The user-specific RS, also called DeModulation Reference Signal (DMRS), can be used for demodulation, while channel estimation measurements for determining user CSI feedback can be performed on so-called Channel State Information Reference Signals (CSI-RS) typically shared by all users in the cell. One reason for introducing such a dual-RS concept may be to exploit that demodulation typically requires much more accurate channel estimates than the estimates needed for CSI feedback. There can consequently be a difference in density between the DMRS and CSI-RS, which balances the signaling overhead by exploiting the fact that the transmission rank to a user is never higher, and is typically much lower than the number of transmit antennas.

In embodiments, the apparatus can be further operable to receive information on a channel quality on the joint radio channel front the mobile transceiver. In other words, the mobile transceiver may measure or estimate the downlink radio channel based on the common or joined reference signal of the TPs of the cluster. For example, CQI may then be provided regarding the joined or common radio channel of the cluster. The apparatus can be further operable to schedule the mobile transceiver for data transmission between the mobile transceiver and the cluster of transmission points based on the information on the channel quality of the joint radio channel. Hence, once the joint radio channel is established and measured or reported by the mobile transceiver, information on the quality of the joint radio channel can be used in a scheduling decision for the mobile transceiver.

In embodiments the means for forming the cluster of transmission points can be operable for randomly selecting the transmission points for the cluster. In other embodiments the means for forming the cluster of transmission points can be operable to select the transmission points for the cluster based on information on a performance of one or more clusters, which had been formed in the past. Hence, a history of data or statistics of former clusters may be evaluated to enable decisions on formations of present and/or future clusters. The means for forming can be operable to store information on a radio channel statistic for a cluster. That is to say that based on radio channel statistics of clusters, which have been formed in the past, and especially of the joint radio channels these clusters provided, present or future clusters can be formed. The means for forming can be operable to store information on a performance of the mobile transceiver for different clusters.

In other words, statistics on past TP cluster scheduling could be used to weigh differently the selection of one TP cluster over another. Moreover, genetic optimization techniques could be used to evolve the cluster selection in a way to match changes in the network. Furthermore, in some embodiments, the means for forming can be operable to store information on a performance of the mobile transceiver for different clusters. For example, data rate information may be stored as a performance measure of a mobile for a certain cluster. Other performance measures, which may be evaluated in embodiments, are Bit or Block Error Rates (BER), Frame Error Rates (FER), a number of retransmissions, packet delays etc. In embodiments the apparatus can be further operable to control the transmission points such that the transmission points or the cluster are operable to communicate jointly with a mobile transceiver. That is to say that the signals communicated between the transmission points of the cluster and the mobile transceiver can be processed jointly.

In some embodiments a separated protocol stack is implemented for each cell of the mobile communication system. Furthermore, using such architecture a joint reception (transmission) from multiple TPs can involve the signal of a given user or mobile transceiver to be decoded by different BBUs over different protocol stacks. The apparatus for controlling transmission points may comprise means for forming/dynamically allocating a cluster of transmission points for joint communication with the mobile transceiver to a set of processing resources to commonly process the radio signals communicated with the mobile transceiver, the cluster of transmission points corresponding to one or more transmission points. In embodiments a cluster may comprise a set of two or more transmission points. The means for dynamically allocating may correspond to an allocator, i.e. a device which is operable to allocate the resources. In embodiments the means for allocating may be implemented as a processor or a controller or any hardware, which is operable to execute an according computer program.

That is to say, the apparatus may assign processing resources to a cluster of transmission points. The cluster of transmission points can be formed to communicate jointly with a mobile transceiver, i.e. the transmission points of the cluster transmit cooperatively to the mobile transceiver. Moreover, the cluster of transmission points is associated to processing resources, which process the signals communicated with the mobile transceiver. In embodiments a transmission point may comprise a radio front end and the plurality of transmission points, i.e. a cluster, may establish a radio coverage structure, which may be cellular in some embodiments, for communicating the radio signals with the mobile transceiver. The plurality of processing resources can be located at a central base band processing unit, which is coupled to the plurality of transmission points.

Embodiments may enable dynamic Cooperative MultiPoint (CoMP) coordination between different transmissions points connected to the same C-RAN base band pool, wherein the base band pool comprises the respective processing resources. In embodiments the means for dynamically allocating can be operable to allocate the set of processing resources to process at least a part of a common base band protocol stack of the cluster of transmission points for the mobile transceiver. In other embodiments the common base band protocol stack of the cluster may be processed by the set of processing resources. In other words, the dynamic allocation may allow gathering all TP, which participate in a CoMP transmission to a certain user, in a cluster, which can be commonly processed by the same resources and therefore suffices a single protocol stack.

TPs can be grouped in clusters, and a given TP can belong to different clusters. That is to say, the means for forming can be operable to allocate at least one transmission point to at least two different clusters of transmission points such that the at least two different clusters of transmission points are operable to communicate with at least two mobile transceivers. The means for forming can further be operable to allocate at least one transmission point to at least two different sets of processing resources. The means for forming can further be operable to allocate two different clusters of transmission points to the same set of processing resources for joint communication to at least two mobile transceivers. That is to say, the same processing resources can also be allocated to different clusters.

In embodiments the clusters can be UE-specific and can be dynamically formed as a function of the users or mobile transceivers to be scheduled. The mean for forming may further be operable to determine the cluster of transmission points for jointly communicating with the mobile transceiver based on radio conditions specific to the mobile transceiver. That is to say, the means for determining may be operable to receive feedback information from the mobile transceiver and may determine the transmission points for the cluster based on the feedback information. In embodiments, such feedback information may comprise parameters or measurement results like channel state information, channel quality indicator, buffer status and so on

In embodiments, the means for forming can be operable to allocate virtual resources of a centralized base band processing unit to the cluster of transmission points. That is to say, virtualization techniques may be used in order to dynamically allocate clusters to hardware resources, which may, for example, be in charge of the Base Band (BB) processing. In other words, embodiments may therewith not need to statically allocate HW resources to a given cluster. Therefore joint processing within a set of transmission points may be realized just by activating an instantiation of a virtual base band chain and by allocating it to a proper set of hardware resources in the pool. Hence, a centralized BB processing pool may be available, such as a cloud of processors, a farm of processors, etc. The processing hardware may be subdivided in virtual resources such as processes, threads, etc. The virtual resources can then be allocated to the cluster, where the cluster size and the transmission scheme, the data rate, the number of radio bearers etc, may determine how many of the processing resources are needed for a particular cluster, user. respectively.

In embodiments architecture may be used, in which the concept of ‘cell’ is redefined and replaced by the concept of clusters. It is a thriller finding of embodiments that the processing resources can be dynamically allocated to sets of transmission points or clusters. These processing resources can be used for jointly transmitting to (or receiving from) a given set of users, i.e. one or more mobile transceivers.

In embodiments a given TP can be dynamically allowed to be associated to different TP sets and can be accordingly dynamically allocated to different sets of processing resources. In other words, processing resources can be dynamically allocated to the pool or CoMP clusters, in a way proportional to the cluster's load. Embodiments may therewith drop the concept of “anchor” TP as from today's 3GPP Release 10 LTE. Embodiments may redefine the pilot structure in a way that the UE may not distinguish between the different TPs. In other words, the means for dynamically allocating can be operable to provide an identification to the cluster of transmission points such that the transmission points of the cluster appear with the same identification to the mobile transceiver. In some embodiments, the cell as the elementary processing unit may be dropped and replaced by a Transmission Point Cluster (TPC), i.e. the set of TPs jointly serving a user or a set of users.

A TP may belong to multiple TPC clusters. That is to say, different users or mobile transceivers can be served by different TPC, where the TPC may not differ in all TPs belonging to them, some TP can belong to multiple TPC. Hence, the means for forming can be operable to provide at least two different identifications to a TP, which belongs to at least two clusters of TPs. The identification may correspond to information on a scrambling sequence used for a pilot signal broadcast by a TP. In embodiments, a mobile transceiver apparatus can be associated to a TP, a TPC, or a base station transceiver, which can be composed of at least one TP and corresponding BB processing resources.

Embodiments further provide a method for controlling transmission points in a mobile communication system. The mobile communication system comprises a plurality of transmission points operable to communicate radio signals with a mobile transceiver. The method comprises forming a cluster of transmission points. The cluster of transmission points comprises multiple transmission points the transmission points of the cluster using a common reference signal.

Embodiments further provide a computer program having a program code for performing one of the above methods, when the computer program is executed on a computer or processor.

Embodiments may provide the advantage data signaling reduction can achieved compared to conventional concepts, where a mobile transceiver may send multiple Channel Direction Indication (CDI) feedbacks, e.g. one for each TP in a TPC. For example, with two candidate TPs for serving a given UE, the UE may send a feedback for the first TP, a feedback for the second TP and a feedback for the joint channel assuming the two TPs transmitting together. Moreover, the two TPs may transmit with different reference signal sequences, to allow the estimation of two separated channels. Embodiments may reduce the signaling overhead by relying on per cluster feedback and per-cluster reference signals.

Moreover, embodiments may reduce the computational complexity of cluster forming. Embodiments may decouple the tasks of user scheduling and clustering, while maintaining the benefit of opportunistically scheduling a good set of users for a given cluster set.

### BRIEF DESCRIPTION OF THE FIGURES

Some other features or aspects will be described using the following non-limiting embodiments of apparatuses and/or methods and/or computer programs by way of example only and with reference to the accompanying figures, in which

FIG. 1 illustrates an embodiment of an apparatus for controlling transmission points;

FIG. 2 illustrates a communication network with multiple TPs as an embodiment; and

FIG. 3 shows a block diagram of an embodiment of a method for controlling.

### DESCRIPTION OF SOME EMBODIMENTS

Various embodiments will now be described in more detail with reference to the accompanying drawings. In the figures, the thicknesses of lines, layers and/or regions may be exaggerated for clarity.

Accordingly, while embodiments are capable of various modifications and alternative forms, embodiments thereof are shown by way of example in the figures and will herein be described in detail. It should be understood, however, that there is no intent to limit embodiments to the particular forms disclosed, but on the contrary, embodiments are to cover all modifications, equivalents, and alternatives falling within the scope of the invention. Like numbers refer to like or similar elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,“ “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly on defined herein.

In the following description some components will be displayed in multiple figures carrying the same reference signs, but may not be described multiple times in detail. A detailed description of a component may then apply to that component for all its occurrences.

Realizing a dynamic resource allocation in real worlds systems, may involve modifying the assumption of the existence of a central unit in charge of channel estimation, detection, scheduling, etc. A distributed implementation, where the logical functions carried out in a CoMP box are distributed between different boards could be assumed. However, this distribution of the CoMP functions may involve a latency that may not always be sustainable.

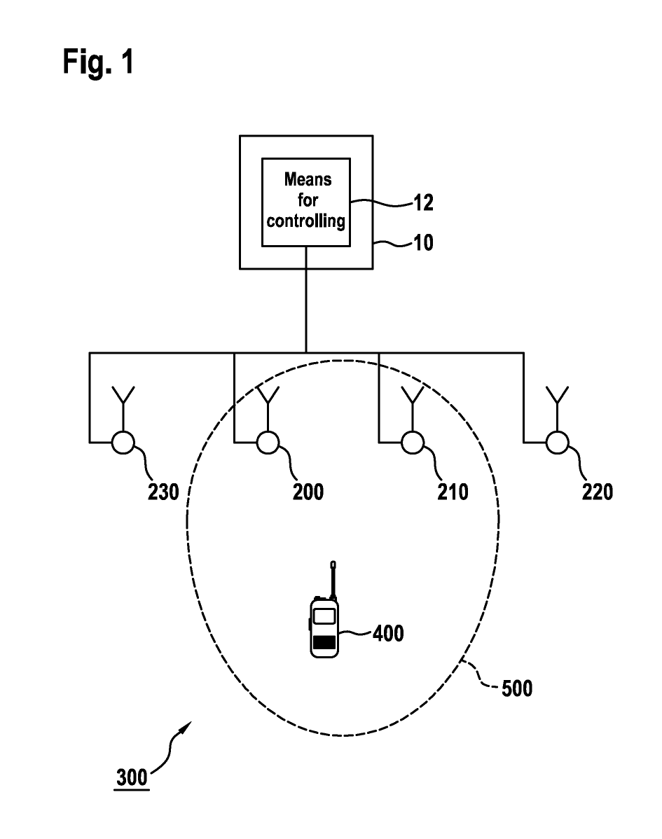

FIG. 1 illustrates an embodiment of an apparatus 10 for controlling transmission points 200; 210, 220, 230 in a mobile communication system 300. The mobile communication system 300 comprises a plurality of transmission points 200, 210, 220, 230 operable to communicate radio signals with a mobile transceiver 400. The apparatus 10 comprises means for forming 12 a cluster 500 of transmission points. The cluster 500 of transmission points comprising multiple transmission points 200, 210, each of which uses a common reference signal. It is to be noted that the common reference signal is common to the TPs 200, 210 of the cluster 500. In other words TPs 200, 210 provide the same reference signal. The transmission points 200, 210 of the cluster 500 use a same cell identification. It is to be noted that the cluster 500, comprising the TPs 200 and 210, is to be understood as an example embodiment, a cluster may comprise one or more TPs. In the embodiment shown in FIG. 1 the apparatus 10 is operable to control the transmission points 200, 210 such that the transmission points 200, 210 are operable to indicate their cell identification using a same scrambling code for transmitting a broadcast signal. The apparatus 10 is operable to control the transmission points 200, 210 such that the transmission points 200, 210 appear as one radio cell to the mobile transceiver 400.

In the embodiment a random clustering is carried out. The principle of random clustering can be summarized as follows:
1. The apparatus 10 creates some random cluster 500. That is to say, the means for forming 12 the cluster 500 of transmission points 200, 210 is operable to randomly select the transmission points 200, 210 for the cluster 500.
2. Reference signals are sent through the different TPs 200, 210 of the cluster 500 as in step 1. That is to say the apparatus 10 is further operable to control the transmission points 200, 210 such that the transmission points 200, 210 provide a common reference signal such that a joint radio channel, being established between the transmission points 200, 210 of the cluster 500 and the mobile transceiver 400, is measurable based on the common reference signal by the mobile transceiver 400.
3. Feedback is received from the users, i.e. mobile 400, about the set of random TPs 200, 210 in the cluster 500 as from step 1 above. That is to say, the apparatus 10 is further operable to receive information on a channel quality on the joint radio channel from the mobile transceiver 400.
4. The apparatus 10 schedules the users with highest weighted (weighted for example by the proportional fair coefficients) rate. That is to say the apparatus 10 is further operable to schedule the mobile transceiver 400 for data transmission between the mobile transceiver 400 and the cluster 500 of transmission points 200, 210 based on the information on the channel quality of the joint radio channel.

Embodiments may generate some artificial fast-fading, e.g. by the use of opportunistic beamforming, with a very low amount of feedback, e.g. only a Signal-to-Interference-and-Noise Ratio (SINR) report. Embodiments may be extended in order to use some predefined sets of TPs rather than randomly selected TPs.

In the embodiment depicted in FIG. 1 the common reference signal corresponds to a Cell-Specific Reference Signal (CS-RS) or a DeModulation Reference Signal (DMRS). Embodiments may to apply this principle to multiple clusters. In order explain the concept some preliminary definitions are given.

A cluster 500 or TP cluster 500 is a subset a subset of TPs 200, 210 cooperating for transmission and/or reception. Scheduling a set of clusters refers to the process of selecting a set of TP clusters for transmission/reception over the same time/frequency/space resource, such that TPs 200, 210 within the same cluster 500 use joint transmission or reception. The apparatus 10 is further operable to control the transmission points 200, 210 such that the transmission points 200, 210 of the cluster 500 are operable to communicate jointly with the mobile transceiver 400. The signals communicated between the transmission points 200, 210 of the cluster 500 and the mobile transceiver 400 are processed jointly.

Cluster 500 scheduling is tightly connected to user 400 scheduling, i.e. the choice of the TPs 200, 210 to group in clusters 500 is connected to the users 400 scheduled for transmission within these clusters 500.

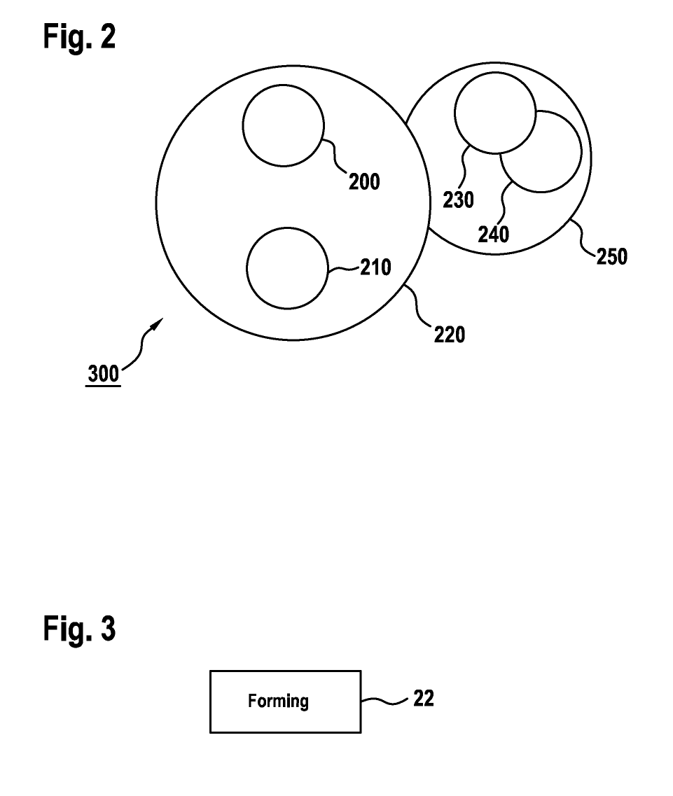

FIG. 2 illustrates a communication network 300 with multiple TPs 200, 210, 220, 230, 240, and 250 as an embodiment. FIG. 2 shows the coverage area of the TPs as a representation of the TPs themselves. The apparatus 10 as described above may be comprised in any one of the TPs. In some embodiments the apparatus 10 can be located at a central unit, which is coupled to the TPs. In other embodiments an apparatus 10 may be comprised in multiple TPs or even in all TPs. FIG. 2 illustrates the coverage areas 200, 210, 220, 230, 240, and 250 as being overlapping and of different sizes. The communication network 300 can be seen as a Heterogeneous Network (HetNet) having TPs with different coverage areas.

In the following TPs of the same cluster are indicated between “[ ]”. Moreover, a set of clusters scheduled for transmission is indicated in between “{ }”.

For example, referring to FIG. 2, the following clusters could be built containing TP 200:

[200], [200, 220], [200, 210, 220], . . . .

Cluster [200, 220] could be scheduled as

{[200, 220], [210], [230, 240, 250]}

or

{[200, 220], [210], [230, 250]}.

where the latter cluster scheduling implies that TP 240 has been turned OFF.

The procedure of the embodiment of the LTE communication network 300 can be summarized as follows:
1. The apparatus 10 is assumed to be located at a central unit. The logical unit with the apparatus 10 generates clusters of TPs and schedules them for transmission. In other words the central unit randomly groups some clusters of TPs for transmission, Joint processing is carried out within each cluster.
2. For each cluster formed, reference signals are sent by each TP in the cluster. TPs belonging to the same cluster use the same scrambling sequence, in a way that a user or a mobile transceiver may be able to distinguish between them but only estimate the joint channel. For example, in Release 10 a TP belonging to the same cluster could use the same port. The term “port” may refer to physical layer interface, a virtual set of antenna, a certain weighted combination of antennas, a certain antenna identification, a combination thereof etc. The term port shall indicate that, at least to some extent, the TPs of a cluster are coordinated such that they appear as one cell to a mobile transceiver served by the cluster and joint processing of the signals transmitted and/or received is enabled.
3. The mobile transceiver sends, for example, an SINR feedback for each cluster as information on the joint radio channel established by the TPs of the cluster.
4. Based on the information on the quality of the joint radio channel, e.g. the SINR feedback, the logical central unit schedules users using the clustering as determined above.

In yet another embodiment a TP may correspond to one antenna out of multiple antennas of one or more base station transceiver. For example, four TPs, TP1, TP2, TP3, and TP4 can be defined, each corresponding to a different antenna. The different antennas can belong to different base stations. In other words, in an example embodiment the four TPs, TP1, TP2, TP3, and TP4 can be defined as each corresponding to a different antenna of a different base station transceiver.

Based on the TPs the following ports can be defined to the following clusters:

Port 1: TP1+TP2,

Port 3: TP3+TP4,

Port 5: TP1+TP3,

Port 7: TP2+TP4.

In the above example one port may correspond to one cluster. That is to say a cluster may be addressed using a certain port. The port in turn can then be used to transmit the common reference symbols.

Further embodiments may extend the above random determination of the clusters by optimizing or improving the clusters. Optimization techniques can be used to schedule the set of TP clusters. Referring to FIG. 1, the means for forming 12 the cluster of transmission points can be operable to select the transmission points 200, 210 for the cluster 500 based on information on a performance of one or more clusters which had been formed in the past. The means for forming 12 can, for example, be operable to store information on a radio channel statistic for the cluster 500. As a matter of fact, statistics on past TP cluster scheduling could be used to weigh differently the selection of one TP cluster over another. Moreover, genetic optimization techniques could be used to evolve the cluster selection in a way to match changes in the network. The means for forming 12 can be operable to store information on a performance of the mobile transceiver 400 for different clusters 500. Hence, the performance statistics on certain clusters may be stored and exploited when forming new clusters.

For example, step 1 in the above process could be modified, such that the logical central unit generates clusters of TP based on information on the past TP clusters and on channel prediction based on channel statistic. Joint processing is assumed within each cluster.

FIG. 3 shows a block diagram of an embodiment of a method for controlling transmission points 200, 210, 220, 230, 240, 250 in a mobile communication system 300. The mobile communication system 300 comprises a plurality of transmission points 200, 210, 220, 230, 240, 250 operable to communicate radio signals with a mobile transceiver 400. The method comprises forming 22 a cluster 500 of transmission points 200, 210, the cluster 500 of transmission points 200, 210 comprises multiple transmission points 200, 210, the transmission points 200, 210 of the cluster 500 using a common reference signal.

In line with the above, further embodiments of the method may comprise providing a common reference signal such that a joint radio channel, being established between the transmission points 200, 210 of the cluster 500 and a mobile transceiver 400, is measurable based on the common reference signal by the mobile transceiver 400. The method can comprise a further step of receiving information on a channel quality on the joint radio channel from the mobile transceiver 400. And the method may comprise a further step of scheduling the mobile transceiver 400 for data transmission between the mobile transceiver 400 and the cluster 500 of transmission points 200, 210 based on the information on the channel quality of the joint radio channel.

Embodiments may further provide a computer program having a program code for performing one of the above methods, when the computer program is executed on a computer or processor.

A person of skill in the art would readily recognize that steps of various above-described methods can be performed by programmed computers. Herein, some embodiments are also intended to cover program storage devices, e.g., digital data storage media, which are ma-chine or computer readable and encode machine-executable or computer-executable pro-grams of instructions, wherein said instructions perform some or all of the steps of said above-described methods. The program storage devices may be e.g., digital memories, magnetic storage media such as magnetic disks and magnetic tapes, hard drives, or optical-\y readable digital data storage media. The embodiments are also intended to cover com-puters programmed to perform said steps of the above-described methods or (field) pro-grammable logic arrays ((F)PLAs) or (field) programmable gate arrays ((F)PGAs), pro-grammed to perform said steps of the above-described methods.

The description and drawings merely illustrate the principles of the invention. It will thus be appreciated that those skilled in the art will be able to devise various arrangements that although not explicitly described or shown herein, embody the principles of the invention and are included within its spirit and scope. Furthermore, all examples recited herein are principally intended expressly to be only for pedagogical purposes to aid the reader in un-derstanding the principles of the invention and the concepts contributed by the inventor(e)to furthering the art, and are to be construed as being without limitation to such specifically recited examples and conditions. Moreover, all statements herein reciting principles, as-pects, and embodiments of the invention, as well as specific examples thereof, are intended to encompass equivalents thereof.

Functional blocks denoted as “means for . . . ” (performing a certain function) shall be understood as functional blocks comprising circuitry that is adapted for performing or to per-form a certain function, respectively. Hence, a “means for s.th.” may as well be understood as a “means being adapted or suited for s.th.”. A means being adapted for performing a certain function does, hence, not imply that such means necessarily is performing said function (at a given time instant).

The functions of the various elements shown in the Figures, including any functional blocks labeled as “means”, “means for forming”, “means for determining”, “means for allocating”, etc., may be provided through the use of dedicated hardware, such as “a former”, “a determiner”, “an allocator”, etc. as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included. Similarly, any switches shown in the Figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

1. An apparatus for controlling transmission points in a mobile communication system, the mobile communication system comprising a plurality of transmission points operable to communicate radio signals with a mobile transceiver, the apparatus comprising
means for forming a cluster of transmission points, the cluster of transmission points comprising multiple transmission points, the transmission points of the cluster using a common reference signal, the reference signal is common to the transmission points of the cluster, wherein phase adjustments or amplitude adjustments or both are carried out on the reference signal at one or more transmission points of the cluster points of the cluster;
wherein the apparatus is further operable to control the transmission points such that the transmission points provide the common reference signal such that a joint radio channel, being established between the transmission points of the cluster and the mobile transceiver, is measurable based on the common reference signal by the mobile transceiver.

2. The apparatus of claim 1, wherein each of the transmission points of the cluster uses a same cell identification and/or wherein the apparatus is further operable to control the transmission points such that the transmission points are operable to indicate a cell identification using a same scrambling code for transmitting a broadcast signal.

3. The apparatus of claim 1, further operable to control the transmission points such that the transmission points appear as one radio cell to the mobile transceiver.

4. The apparatus of claim 1, wherein the common reference signal corresponds to a cell-specific reference signal or a demodulation reference signal.

5. The apparatus of claim 1, further operable to receive information on a channel quality on the joint radio channel from the mobile transceiver.

6. The apparatus of claim 5, further operable to schedule the mobile transceiver for data transmission between the mobile transceiver and the cluster of transmission points based on the information on the channel quality of the joint radio channel.

7. The apparatus of claim 1, wherein the means for forming the cluster of transmission points is operable to randomly select the transmission points for the cluster.

8. The apparatus of claim 1, wherein the means for forming the cluster of transmission points is operable to select the transmission points for the cluster based on information on a performance of one or more clusters which had been formed in the past.

9. The apparatus of claim 5, wherein the means for forming is operable to store information on a radio channel statistic for the cluster.

10. The apparatus of claim 5, wherein the means for forming is operable to store information on a performance of the mobile transceiver for different clusters.

11. The apparatus of claim 1, further operable to control the transmission points such that the transmission points of the cluster are operable to communicate jointly with the mobile transceiver.

12. The apparatus of claim 1, wherein the signals communicated between the transmission points of the cluster and the mobile transceiver are processed jointly.

13. A method for controlling transmission points in a mobile communication system, the mobile communication system comprising a plurality of transmission points operable to communicate radio signals with a mobile transceiver, the method comprising
forming a cluster of transmission points, the cluster of transmission points comprising multiple transmission points, the transmission points of the cluster using a common reference signal, the reference signal being common to the transmission points of the cluster; and
controlling the transmission points such that the transmission points provide the common reference signal such that a joint radio channel, being established between the transmission points of the cluster and the mobile transceiver, is measurable based on the common reference signal by the mobile transceiver.

14. A computer program having a program code for performing the method of claim 13, when the computer program is executed on a computer or processor.
